(19) United States
(12) Patent Application Publication
(10) Pub. No.: US 2002/0107810 A1
(43) Pub. Date: Aug. 8, 2002

(54) Service provider system

(76) Inventors: Takanori Nishio, Yokohama (JP); Mikito Ogata, Odawara (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/886,350

(22) Filed: Jun. 21, 2001

(30) Foreign Application Priority Data
Feb. 2, 2001 (JP) P2001-026245

(51) Int. Cl. G06F 17/60

(52) U.S. Cl. 705/59

(57) ABSTRACT

The present invention provides a method and system for providing storage service functions to customer's based on the number of users and/or capacity of storage use for each service function. In an exemplary embodiment the storage system has a licensing system that has a predetermined maximum number of users and/or storage capacities for each service function provided. Each storage device in this embodiment has a licensing function that keeps track of users and capacity for each storage function for that device. The charge to the service provider by the vender is dependant upon the values chosen for the maximum number of users and/or total capacity used by each service function.

### CROSS-REFERENCES TO RELATED APPLICATIONS

This application is related to and claims priority from Japanese Patent Application No. 2001-026245, filed on Feb. 2, 2001

### BACKGROUND OF THE INVENTION

The present invention relates generally to data storage systems and more particularly to data storage system usage by a service provider system providing storage services to customers.

FIG. 1 illustrates two conventional models of storage system usage. In the first the device vender 10 produces and programs a device 12, for example, a disk storage system, and sells the device to a single user 14, who the uses the device 16. The conventional storage system is programmed by the vender to support or not-support one or more service functions. The device purchaser, being also the user, selects and pays for these service functions depending on the user's needs.

In today's market the device purchaser and the device user may also be two separate entities. Thus in the second model, shown in FIG. 1, the device purchaser has become a service provider 18. The service provider 18 provides services using the device to multiple users 22. The service provider 18 generally charges each user for use of the services (e.g., 24-1 to 24-3). However, the service provider 18, had previously purchased the device based on the service functions needed, not on the actual users of the services. Thus it would be better for the service provider 18 to purchase those service functions according to the number of users of the service functions and in addition, the maximum capacity of the storage system required to access those service functions than purchasing those service functions by device.

U.S. Pat. No. 6,012,032 discloses an accounting method in which a service provider provides a user with the basic functions of the device and other additional values. According to this accounting method, each user is charged according to such service options such as the access speed, the price per bit, etc. The service provider in the meantime prepares different type storage systems so as to distinguish the access of the user from others according to his/her service option.

FIG. 2 shows a system similar to that described in the above US Patent. There are a plurality of customers, 30, 32, 34, and 36, who receive services 46, for example, Program Products(PP) PP1 48, PP2 50, PP3 52 and PP4 54, through a service provider 38. The service provider 38 hides which devices it uses (e.g., Devices 40, 42, and 44) from the customers. Inotherwords, the Service Provider 38 serves as a middleman that allows the customer to concentrate on the PP's, the customer needs without being concerned of how those services are provided. Each device is purchased from a vender by the service provider 38 with a selected number of services/service functions/PP's turned on. For device-1 40 PP1 58 is turned on and the other PP's turned off. For device-2 PP2 60 is turned on. For device-3 44 PP2 62 and PP3 64 are turned on. The Service Provider has the problem of what devices with what PP's to buy. The vender has a problem in that the vender normally charges the service provider for each PP regardless of the number of users or the storage capacity used for that PP. Thus the vender is not able to grow with the service provider's business, for example, by lowering its initial price for the service functions, but receiving more revenue as the service providers users grow.

Thus there is a need for a Storage Provider System (SPS) and a storage system that allows more flexible access to the service functions provided by the storage system and allows the storage system vender to charge on the basis of usage and/or capacity of the storage functions provided.

### SUMMARY OF THE INVENTION

The present invention provides a method and system for providing storage service functions to customer's based on the number of users and/or capacity of storage use for each service function. In an exemplary embodiment the storage system has a licensing system that has predetermined maximum number of users and/or storage capacities for each service function provided. All the service functions are turned on for each device and available to the service provider within the license constraints. Each storage device in this embodiment has a licensing function that keeps track of users and capacity for each storage function for that device. The charge to the service provider by the vender is dependant upon the values chosen for the maximum number of users and/or total capacity used by each service function. Thus the vender has a more flexible storage system, that allows both large service providers with many users and small businesses with a small number of users. The cost being scaled on number of users and/or storage used or required for each service function.

While the conventional technique has the vender preset one or more service function for each storage system provided to a SSP, and has the vender set prices for each of those storage systems based on the set of service functions activated, one embodiment of the present invention enables the storage system to manage/control the number of users who use this service and the total capacity of the storage resource used by the service user, thereby the price of each service function provided to the SSP is set according to the number of users who use the service and the total capacity of the storage resource used by those users.

One embodiment of the present invention provides a method for providing service functions to users by a storage system, including: receiving a request by a user of for performance of a service function; checking if the service function is allowed by the storage system according to a usage constraint, where the usage constraint includes a storage area needed by the service function; and when the service function is allowed, performing the service function by the storage system.

A second embodiment of the present invention provides a service provider system for providing service functions to users, The service provider system includes a storage system having the service functions, where a service function has a predetermined limit on a number users that have access to the service function; and a service provider server for providing the users with the service functions of the storage system.

In a third embodiment a storage system for providing a plurality of service functions to a plurality of users via a service provider system is provided. The system includes a user access information data structure indicating for a service function which of the users has access to the service function; a controller for checking the user access information data structure, when receiving a request from the service provider system for access by a user of the plurality of users to the service function; and a storage unit used when the service function is performed.

A forth embodiment provides a method for providing a plurality of service functions on a plurality of storage systems to a plurality of users via a service provider system. The method includes, the service provider system receiving a request for performance of a service function from a user. A selected storage system is determined based on the user and the service function; next, a storage area needed by the service function is calculated; and when the storage area added to a total storage area presently required by other users of the service function on the selected storage system does not exceed a predetermined total capacity for the service function on the selected storage system, the storage area is used to perform the storage function.

A fifth embodiment provides a method of payment for services from a service provider system to a storage system, wherein the service provider system provides a plurality of service functions of the storage system to a plurality of users. The method includes, for a service function, a set of limitations is determined based on a total number of users of the service function and a total capacity of storage area used by the total number of users. For each limitation in the set, a price is set; and a given price is paid by the service provider for a selected limitation of the set, such that an actual number of users of the service function on the storage system and an actual total capacity of storage area used by the actual number of users does not exceed the selected limitation.

A sixth embodiment provides a licensing system of a storage system for monitoring a service provider system having a plurality of customers using a plurality of service functions. The licensing system includes: the plurality of service functions stored on the storage system; an access table having authorized customers that have access to a service function and a total capacity of storage area needed by the authorized customers when using the service function; and a license checking routine for receiving a customer request for the service function from the service provider system, and determining if the customer request is within a license limit. The license limit has combinations for the service function of maximum number of users versus maximum total storage capacity allowed for the maximum number of users.

A seventh embodiment provides a method for providing a service function to a user by a storage system, including: receiving a request by a user for performance of a service function; checking if said service function is allowed by said storage system according to a usage constraint, said usage constraint comprising a storage area needed by said service function; and when said service function is allowed, performing said service function by said storage system.

These and other embodiments of the present invention are described in more detail in conjunction with the text below and attached figures.

### BRIEF DESCRIPTION OF THE DRAWINGS

FIG. 1 illustrates two conventional models of storage system usage.

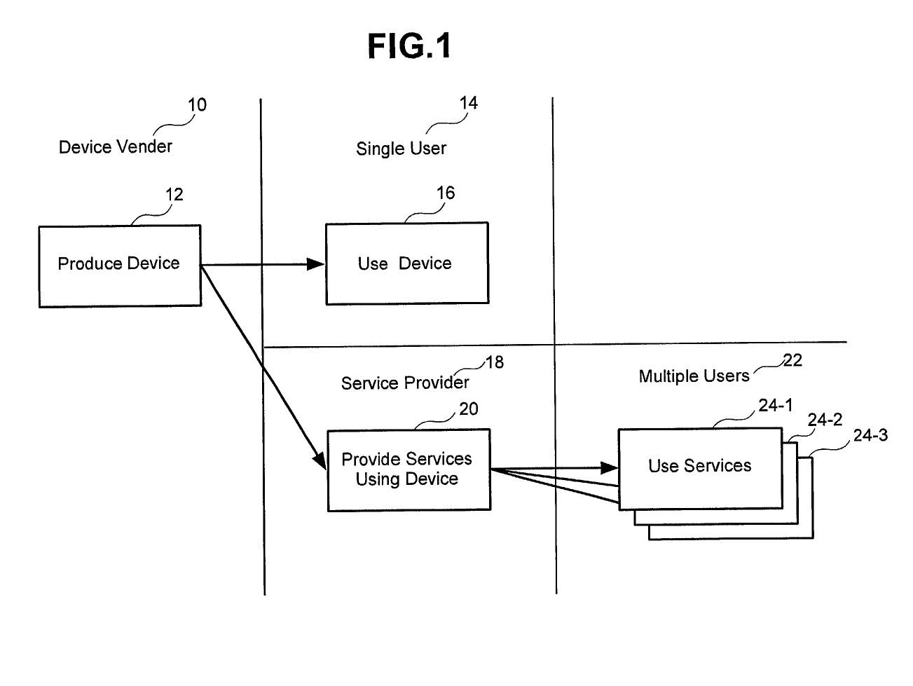

FIG. 2 shows an example of Program Products usage.

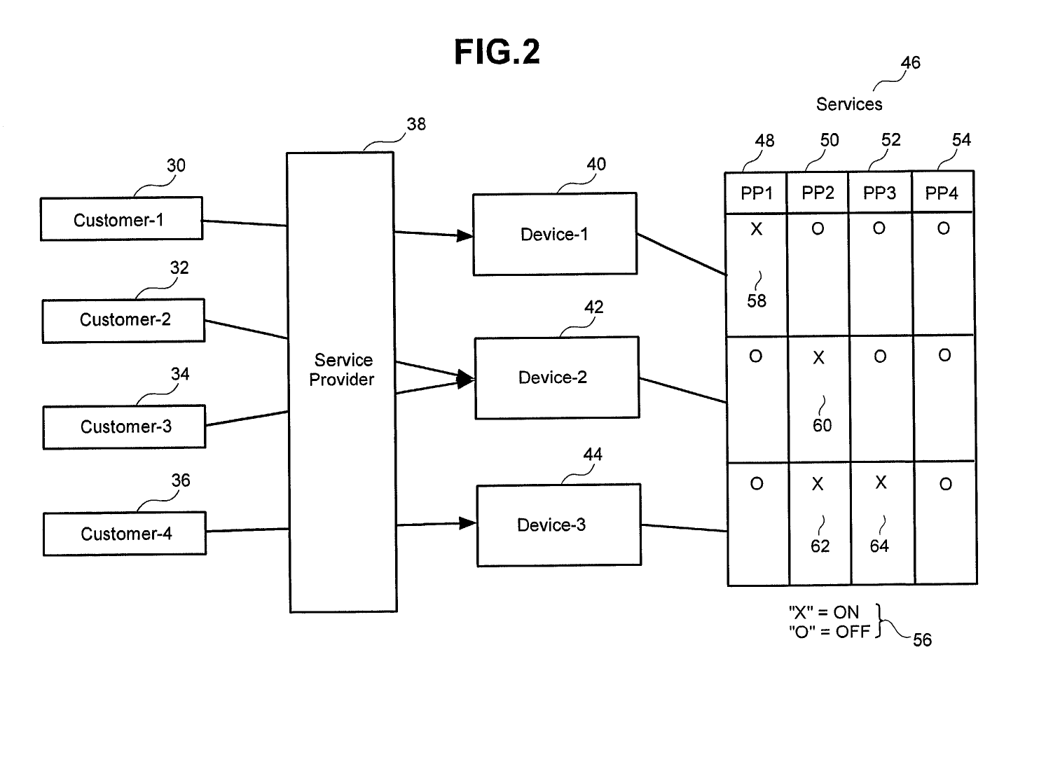

FIG. 3 shows a block diagram of a service provider system architecture of an embodiment of the present invention;

FIG. 4 is a configuration of a user data management table of an embodiment of the present invention;

FIG. 5 is a simplified example of the user data management table of another embodiment of the present invention for a plurality of storage systems.

FIG. 6 is a configuration of a user access information table of an embodiment of the present invention;

FIG. 7 shows a simplified example of user access information table for storage system of an embodiment of the present invention;

FIG. 8 shows an illustrative example of a licensing model that may be used by a storage device vender of an embodiment of the present invention;

FIG. 9 is a flowchart of the service provider server operation carried out in response to a received access command of an embodiment of the present invention;

FIG. 10 is a flowchart of the service provider server operation carried out in response to a received service command of an embodiment of the present invention;

FIG. 11 is a flowchart of the storage controller operation carried out in response to a received service command of an embodiment of the present invention;

FIG. 12 is a flowchart of the processing for reserving a new data area of an embodiment of the present invention; and.

FIG. 13 is a flowchart of the processing for supporting a new service function of an embodiment of the present invention.

### DESCRIPTION OF THE SPECIFIC EMBODIMENTS

Preferred embodiments of the present invention will be described with reference to the accompanying drawings.

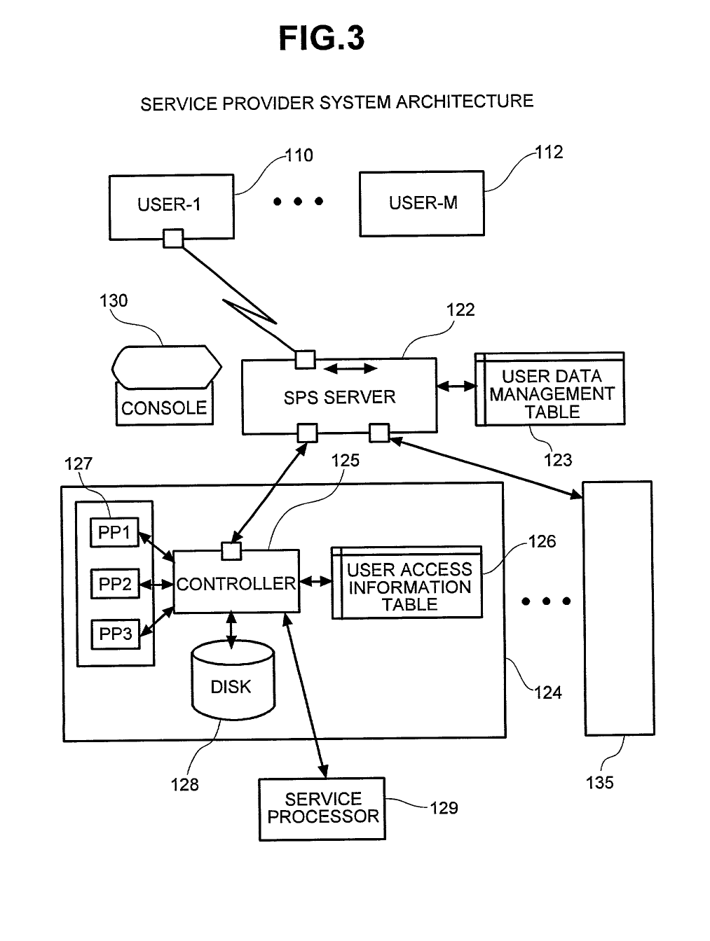

FIG. 3 shows a block diagram of a service provider system(SPS) architecture of an embodiment of the present invention. The SPS is configured by a SPS server coupled to a plurality of user computers, for example, users 110 and 112, via a communication network and a plurality of storage systems, for example, 124 and 135, operated under the control of the SPS server.

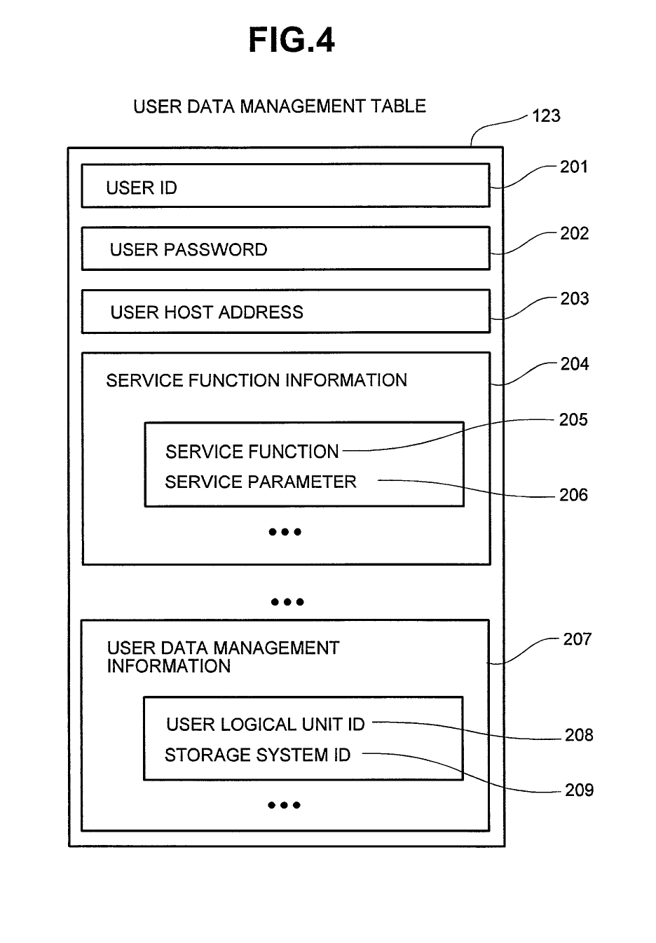

A SPS server 122 interfaces between for example, user-11 10, that uses a storage system 124, including a data storage area 128 in a storage system 124. The service provider purchases storage system 124, including service functions, for example, the Provider Programs (PP's) from a storage system vender. The PP's include such functions as, for example, asynchronous remote copy, extended remote copy, multi platform backup/restore, open asynchronous remote copy, open remote copy, remote copy, shadowAImage, synchronous remote copy, LUN manager, LDEV Security, or LUN size expansion (other example may be found at http://www.hds.com/9900/spec6.html). The service provider communicates with the SPS server via management console 130. The user 110 that uses this system is registered beforehand in a user data management table of the SPS server 122. The a user data management table 123 may be stored internally or externally to the SPS Server 122. The registered information (FIG. 4)includes items of user ID 201, user password 202, user host address 203, service function information 204, and user data management information 207. The service function information 204 includes items of service function 205, i.e., PP, provided to the user and parameter information 206 required by the service function. The user data management information 207 is used to manage the data under the control of this system as entrusted by the user of the user ID 201. A serial number is given to each user host 110. A logical unit accesses this user data management information 207. Actually, however, the logical unit is mapped in the logical data ID of each of a plurality of storage systems 124 connected to the SPS server 122. Consequently, the user data management information 207 is managed so as to correspond a storage system ID 209 to a logical unit ID 208 assigned to each user.

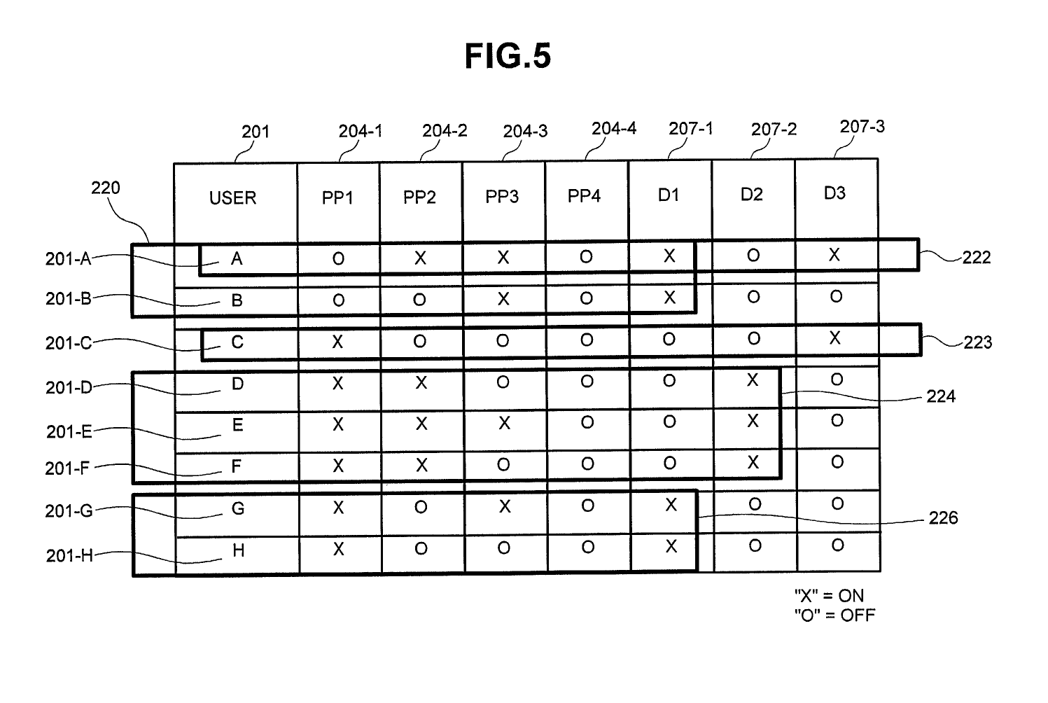

FIG. 5 is a simplified example of the user data management table 123 of another embodiment of the present invention for a plurality of storage systems. In column one 201 is the user ids A 210-A through H 201-H. Columns two through five give the service functions, PP1 204-1 through PP4 204-4 that are turned on in every storage system and correspond to service function information 204 of FIG. 4. The three storage systems are given by Disks D1 207-1, D2 207-2, and D3 207-3 corresponding to user data management information 207 in FIG. 4. Each disk is in one storage system, storage system 124 (disk 128 in FIG. 3), storage system 135 (disk in 135 in FIG. 3), and storage system 140 (not shown). For example, user A 201-A, has permission to use PP2 204-2 (“X” means activated, while “O” is OFF), PP3 204-3, and PP4 204-4 and has access to D1 207-1 and D3 207-3.

The user access information table for each storage system, e.g., 124, 135, 140, in the embodiment illustrated by FIG. 5, includes subsets of the FIG. 4 table 123. For example, user access information table 126 corresponding to D1 207-1 includes areas 220 and 226 (users A 201-A, B 201-B, G 201-G, and H 201-H). The user access information table corresponding to D12 207-2 includes the areas 222 and 223 (users A 201-A and C 201-C). The user access information table corresponding to D3 207-3 includes area 224 (users D 201-D, E 201-E, and F 201-F).

As shown in FIG. 3, the storage system 124 is connected to the SPS server 122 and is controlled by a controller 125. The controller 125 is coupled to a user access information table 126 used to manage user data in the system, a service function 127 used to execute a service type, for example a PP, for the user, and a data storage area 128 used to store/manage user data.

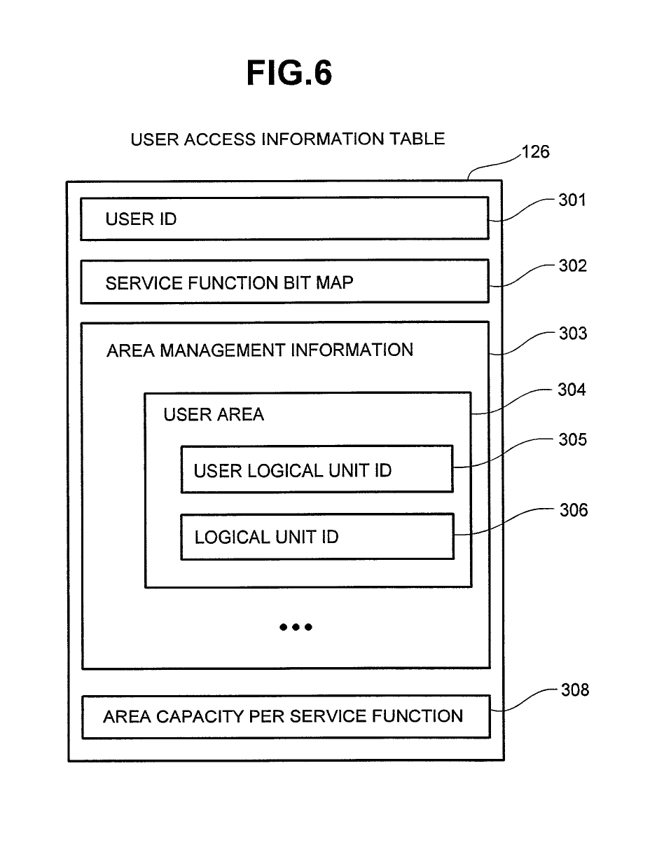

The user access information table 126, as shown in FIG. 6, includes a user ID 301, service function bit map 302, area management information 303, and area capacity 308 per service function per user. The service function bit map 302 holds each service function allowed for each user represented by the user ID 301 as a bit map. The area management information 303 holds the logical unit ID 306 of an area occupied by the storage system with respect to the user logical unit ID 305. This logical unit ID 306 is used to access subject data.

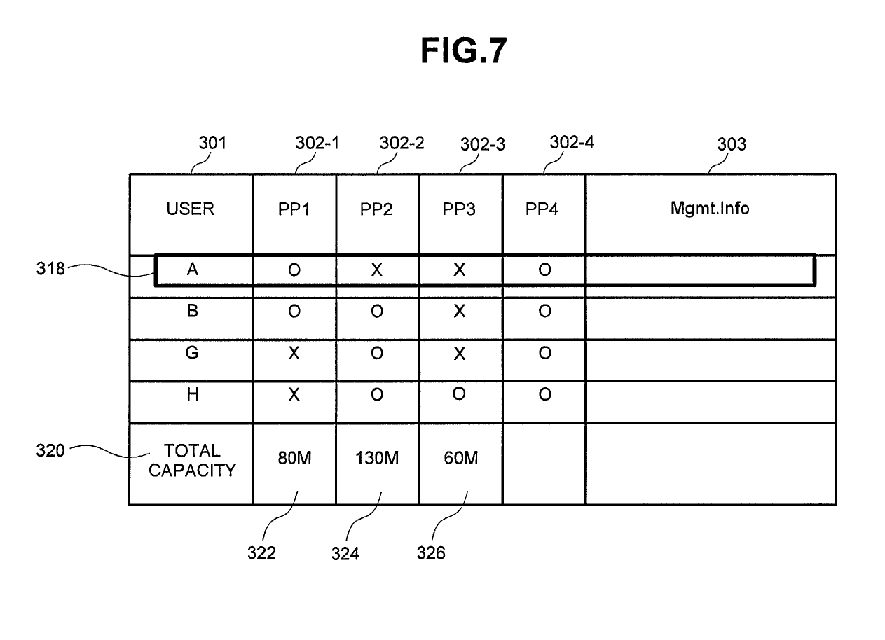

FIG. 7 shows a simplified example of user access information table 126 for storage system 124 of an embodiment of the present invention. User Id 301 is shown for users A, B, G, and H, which have access to disk 128. The service function bitmap 302 of FIG. 6 is illustrated by the columns showing PP1 302-1, PP2 302-2, PP3 302-3, and PP4 302-4. User A has permission to use, for example, PP2 302-2 and PP3 303-3, bitmap “0110,” as shown by row 318. User A also has an area capacity 308 for PP2 and an area capacity 308 for PP3. For a service function each area capacity is added per user, i.e., area 308 and the total given in Total Capacity row 320. For example, the total capacity for PP1 302-1 is 80 Megabytes 322 for users G and H. PP2 302-2 has one user A with a total storage capacity use of 130 Megabytes. Many users with small use of storage may effect the storage system 125 as much as one user accessing a large capacity. The many users may tax the controller 125, while the one user may tax the disk 128. Thus there may be a balancing of number of users and storage usage for the PP.

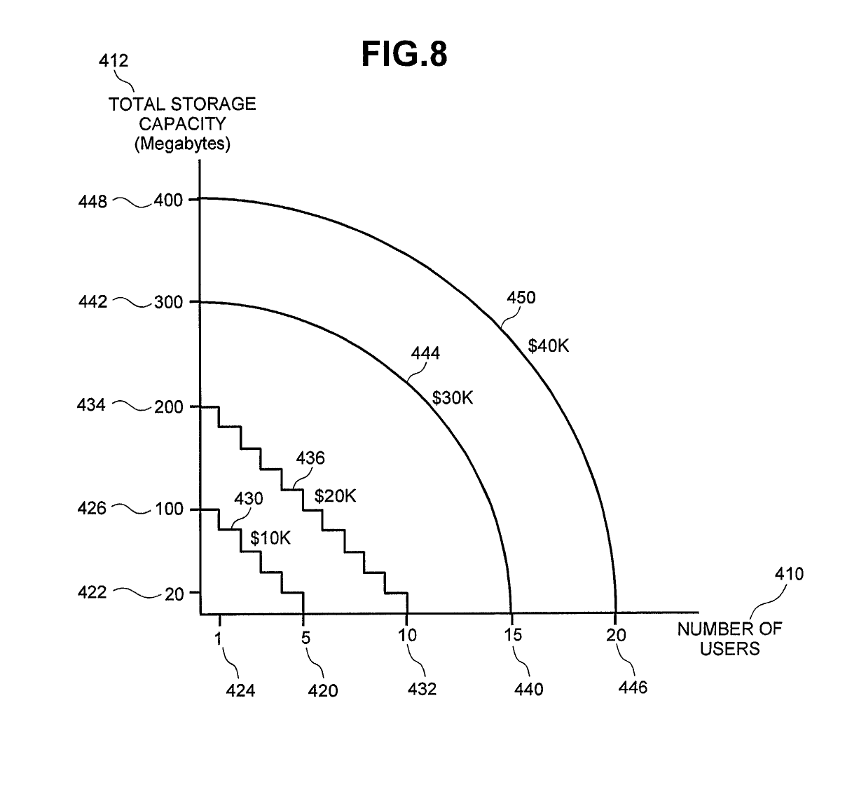

FIG. 8 shows an illustrative example of a licensing model that may be used by a storage device vender of an embodiment of the present invention. The numbers shown are for illustration purposes only. The x-axis 410 shows the number of users of a PP of a storage system. The y-axis 412 shows the accumulated total storage capacity allocated (or used) in megabytes for the number of users given on the x-axis 410. The stepwise graph 430 shows for 5 users 420 there is 20 Meg 422 used. For 1 user 424 there is 100 Meg 426 used on graph 430. For 10 users 432, the graph 436 shows 20 Meg 422 used. And for one user 424 the graph 436 shows 200 Meg being used. The stepwise graphs 430, and idealized graphs 44 and 450 represent licensing limits that are checked by the controller 125 of storage system 124. For example if the SSP pays $10K to the vender, then graph 430 is used. As long as the x-y combination is within graph 430, e.g., 2 users with 30 Megs total storage capacity, the controller in checking the licensing file will allowed the service function to execute. If the service provider has 6 users using 60 megs, he/she need to license to (and pay for) the next level, i.e., $20K for graph 436. In another embodiment only the number users 410 is used to set the license. In yet another embodiment only the total storage capacity 412 per PP per storage system is used to set the license.

The command issued by a user host specifies either an access to data stored in the storage system (access command) or execution of a service function (service command) supported by the subject storage system.

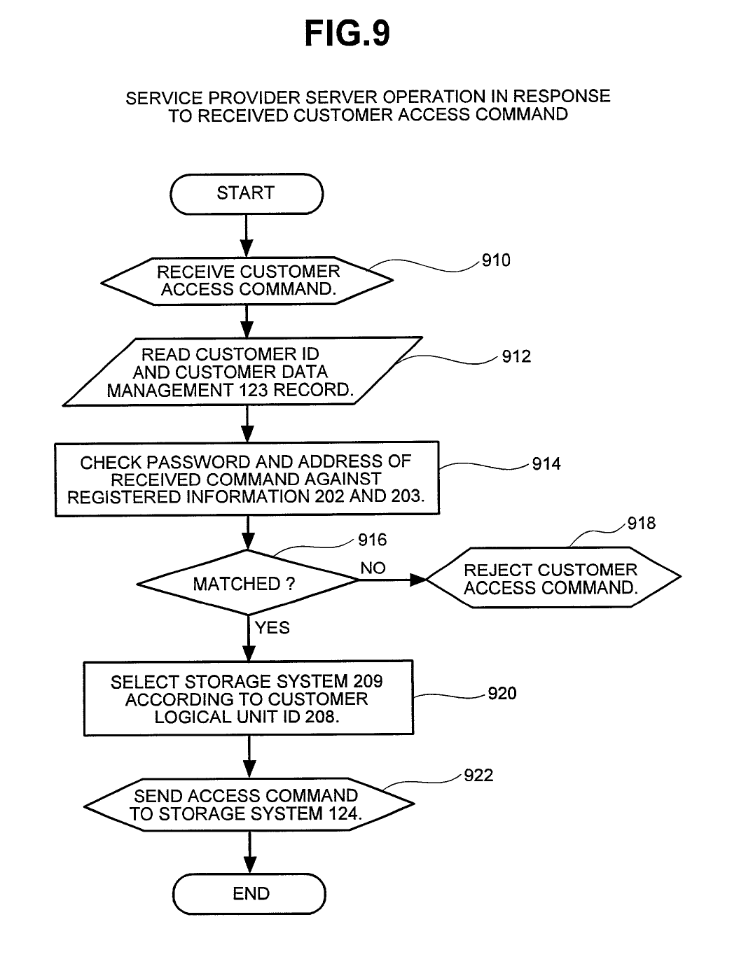

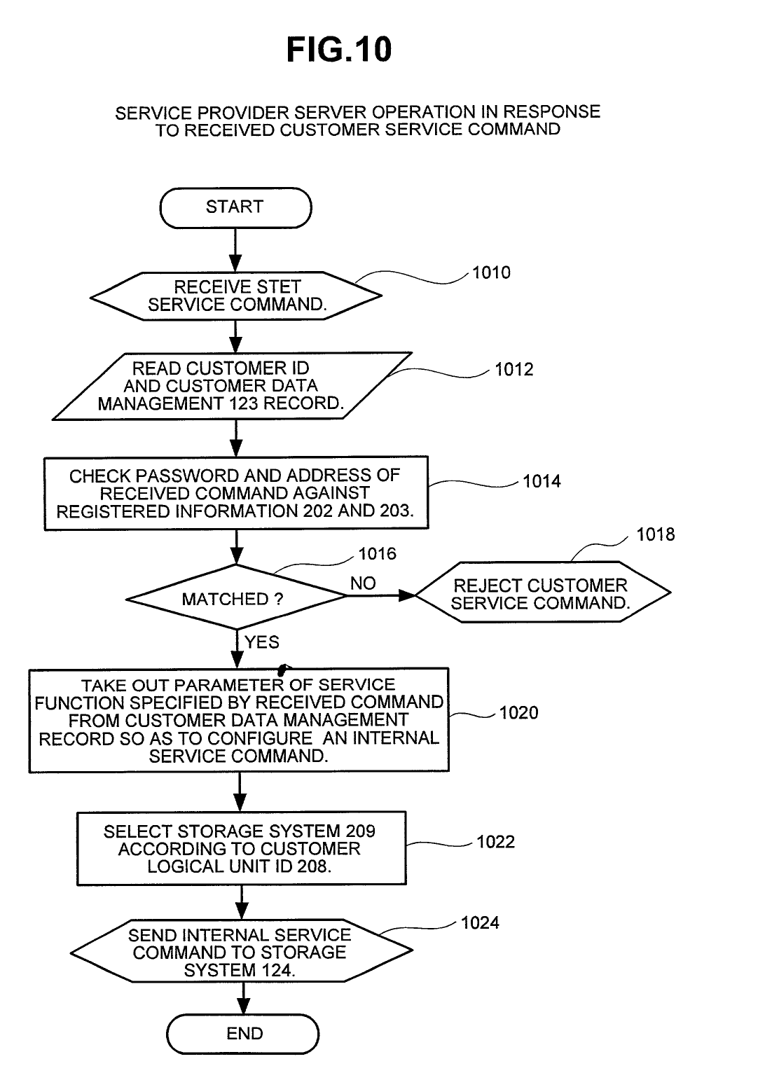

Hereinafter, a description will be made for the operation of the service provider server 122 to be carried out in response to a received access command or service command with reference to FIGS. 9 and 10.

When receiving an access command from a user, the service provider server 122 carries out the processing in accordance with the flowchart shown in FIG. 9. Specifically, upon receiving an access command from a user (step 910), the server 122 reads the user ID from the user data management table 123( step 912). Because user information can be identified from the user ID, the server 122 checks the password and the address included in the received access command against the user password 202 and the user host address 203 set in the table 123 (step 914).

Where the check result(step 916) is OK (matching), the server 122 selects the storage system ID 209 from the user logical unit ID 208 (step 920), then sends the access command to the storage system 124(step 922).

However, where the check result is NG (unmatching), the server 122 regards the access command received from the user as non-registered one, thus rejects the command(step 918).

When receiving a service command from a user, the service provider server 122 carries out the processing in accordance with the flowchart shown in FIG. 10. Specifically, upon receiving an access command from a user (step 1010), the server 122 reads the user ID from the user data management table 123 (step 1012). Because user information can be identified from the user ID, the server 122 checks both password and address included in the received an access command against the user password 202 and the user host address 203 set in the table 123 (step 1014). The processing up to this step are the same as those of the server 122 carried out in response to an access command received from a user. The server 122 checks the user information according to the access command received from the user.

Where the check result is OK(matching), the server 2 creates an internal service command for the service function specified by the access command received from the user data management table 123 by taking out the service parameter 206 from the service function information 204 set in the user management table 123(step 1020). Then, the server 122 selects the storage system ID 209 from the user logical unit ID 208 (step 1022) and sends the internal service command to the storage system 124(step 1024).

However, where the check result is NG (unmatching), the server 122 regards the service command received from the user as a non-registered one, thus rejects the command just like in the processing carried out in accordance with the flowchart shown in FIG. 9.

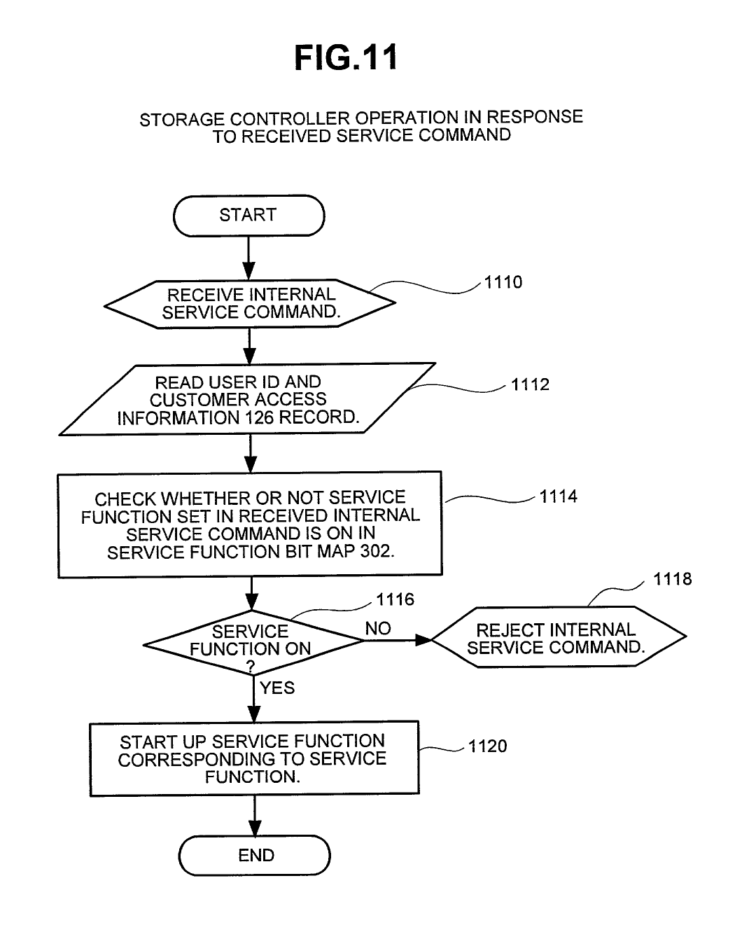

Next, a description will be made for the operation of the controller 125 carried out in response to a received internal service command with reference to FIG. 11.

As described above, when the service provider server 122 receives a service command from a user, the storage system 124 receives the generated internal service command from the service provider server 122. In this case, the internal service command received by the storage system 124 is actually received by the controller 125 located in the storage system 124 (step 1110).

Where the controller 125 receives an internal service command (step 1110), the controller carries out the processing in accordance with the flowchart shown in FIG. 11. Specifically, the controller 125 reads the user ID from the user access information table 126 (step 1112) in response to the service command received from the service provider server 122. The controller 125 then checks whether or not the service function requested by the received internal service command is turned on in the service function bit map 302 located in the user access information table 126 (step 1114).

Where the check result is OK (the service function is turned on in the bit map 302), the controller 125 starts up the service function 127 corresponding to the service function, e.g. PP, requested by the received service command (step 1120).

Where the check result is NG (the service function is not turned on in the bit map 302), however, the controller 125 cannot start up the service function 127, thus sends the effect that the internal service command has been rejected, to the service provider server 122 (step 1118).

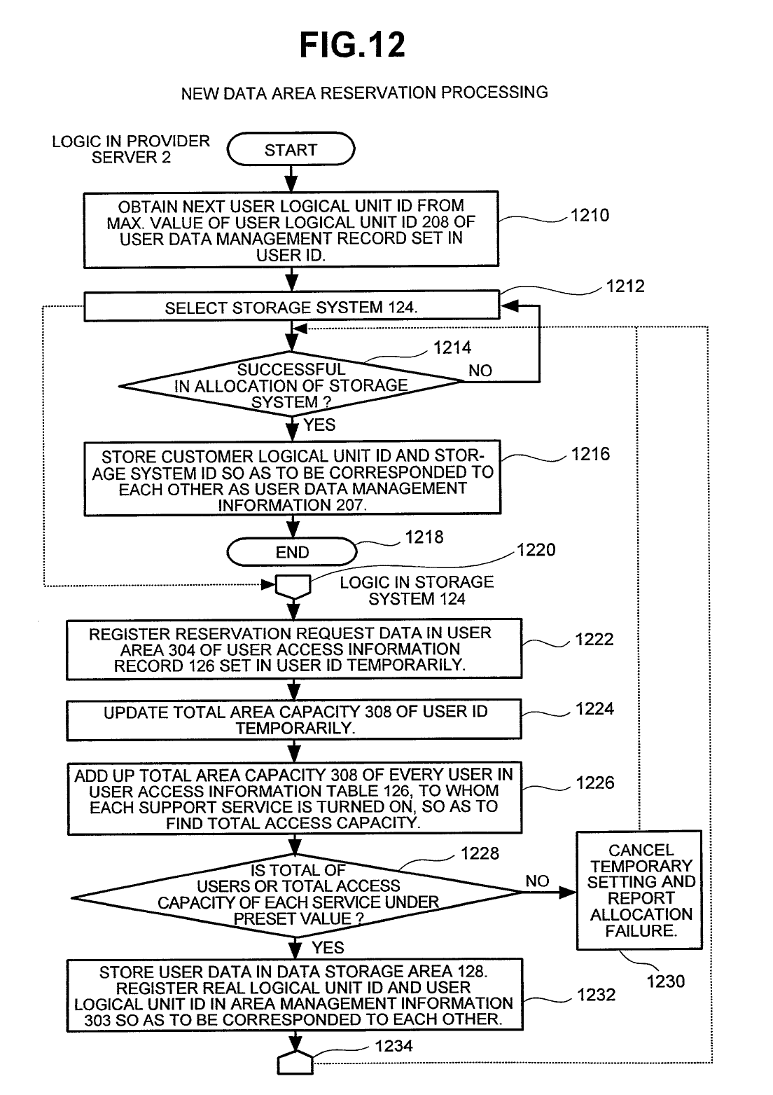

Next, a description will be made for how a new user data area is reserved with reference to FIG. 12. In this case, the service provider server 122 sets the user ID 201 for the new user in the user data management table 123. Specifically, the server 122 searches the maximum value of the user logical unit ID 208 from among the user data management information 207 located in the user data management table 123. The server 122 then assigns the logical unit ID next to the maximum value as the logical unit ID of the new user (step 1210).

Then, the server 122 selects a storage system 124 (step 1212) and assigns a storage system ID 209 taken from the user data management information 207 to the new user in the same way as the above. The server 122 then registers the new user logical unit ID and the storage system ID obtained as described above as user data management information 207 in the user data management table 123 (step 1216). The new user logical unit ID and the storage system ID are corresponded to each other.

On the other hand, the selected and allocated storage system 124 registers the user ID data temporarily in the user area 304 of the user information table 126 (step 1222). Then, the storage system 124 updates the total area capacity 308 temporarily so as to be corresponded to the temporary registered capacity (step 1224).

In principle, where new user information is registered in or deleted from the user access information table 126, the storage system 124 calculates the registered or deleted user data area capacity again. Then, the storage system 124 updates the total area capacity 308 according to the calculated total area capacity. The storage system 124 then reserves user data in the data storage area 128 according to the updating result and registers the new data in the user area 304 with respect to the user whose information has been changed (step 1232).

Where the total capacity used by each service exceeds a predetermined value as a result of addition of newly registered data of a user after the total capacity used by all the users in the total area capacity 308 is calculated again with respect to each service supported for the newly registered user (step 1226), the storage system 124 regards the reservation of the new data in itself as failure, thus cancels the processing to be carried out after the temporary registration in the user area 304 for new registration and sends a message denoting the assignment failure of the storage system 124 to the service provider server 122 (step 1230). The service provider server 122 then selects another storage system 124 and repeats the same processing as described above.

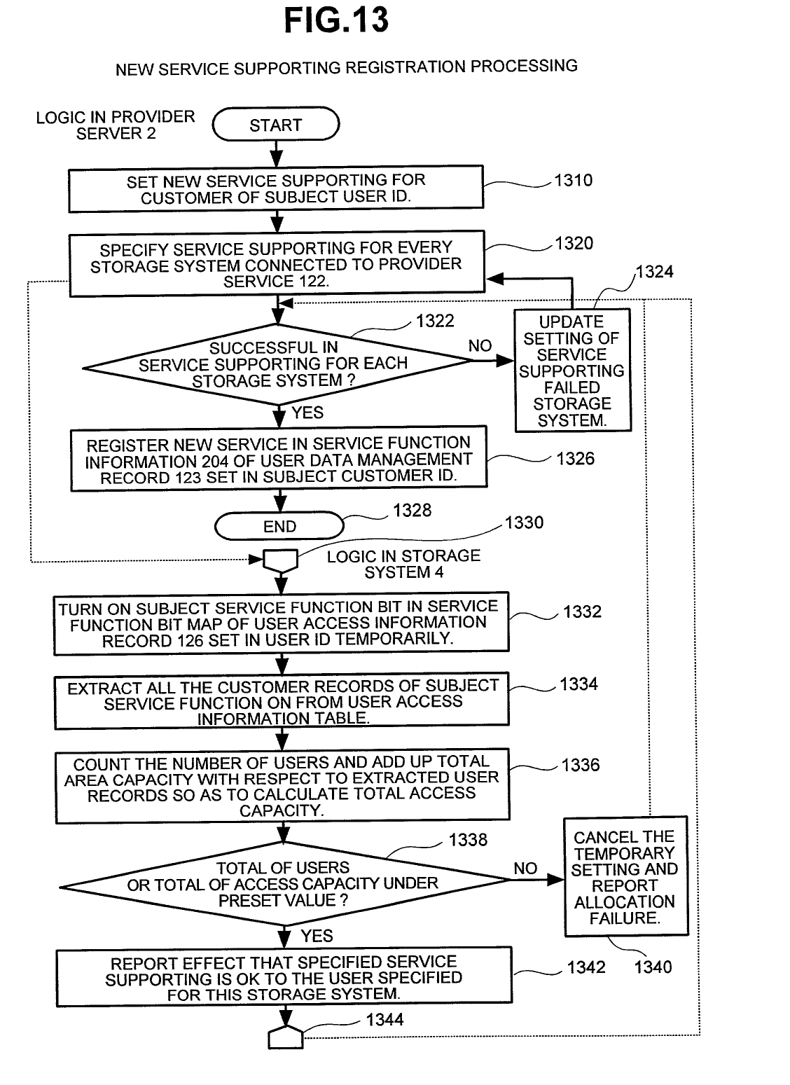

Next, a description will be made for the processing carried out when new user data is registered, when new service supporting is contracted with a user, or when existing service supporting is canceled with reference to FIG. 13 respectively. The flowchart shown in FIG. 13 indicates a procedure for the processing carried out when new service supporting is contracted with a user. In this case, the service provider server 122, when a user enters items for setting new service supporting (step 1310), instructs every storage system 124 connected thereto so as to set necessary items for the new service supporting (step 1320). Receiving the instruction, each storage system 124 sets the items for the specified service supporting. Completing the setting, the server 122 adds the new service data to the service function information 204 in the user data management table 123 (step 1326). However, where the setting is not carried out, the server 122 feeds back the effect (step 1324) and carries out the subsequent processing that follow the setting of the service supporting (step 1330) again.

At the same time, the server 122 extracts a storage system 124 that is connected thereto and stores the data of the user who has accessed from the user data management information 207. The server 122 then searches the service function bit map 302 of the same user ID from the user access information table 126 located in each storage system 124 so as to turn on the subject service temporarily (steps 1332 and 1334).

Here, the number of users to which the same service is supported and the total capacity used by the users in the total area capacity 308 are counted with respect to all the users of the same storage system 124 (step 1336). If the counted values exceed limiting combinations of the total number of users and the total capacity used by those users set for each service in the storage system 124, the storage system 124 reports the effect that the number of users or the total data capacity exceeds a predetermined value, to the service provider server 122 (step 1340). If the total number of users and the total capacity used are within the predetermined limiting combinations, a successful setting is reported by the service provider server to the user (step 1344). The service provider server 122 regards the setting as successful unless it receives the effect that each of the subject storage systems 124 exceeds the predetermined value. Where the server 122 receives a report that at least one of the storage systems 124 exceeds the predetermined value (step 1324), the server 122 allocates another storage system 124 (step 1320) and proceeds the same processing (step 1330). If setting fails for all the rest storage systems 124, the server 122 reports the user that the requested service supporting is disabled (not shown).

The total number of users and the total data capacity to be assigned to each storage system 124 are decided between the service provider of this storage system 124 and the vender. Those information items are set as service function management information of the storage system 124. Even when the storage system runs, those items can be set/updated from the service processor 129 of this storage system 124.

Another embodiment provides for a computer program product stored on a computer readable medium for providing a plurality of service functions to a plurality of users by a storage system, said computer program product including: code for receiving a request by a user of said plurality of users for performance of a service function of said plurality of service functions; code for checking if said service function is allowed by said storage system according to a usage constraint, said usage constraint comprising a storage area needed by said service function; and code for when said service function is allowed, performing said service function by said storage system.

Yet another embodiment provides for a computer program product stored on a computer readable medium for licensing a service provider system, having a plurality of customers using a plurality of service functions, by a storage system, said computer program product including: code for said plurality of service functions stored on said storage system; code for a access table comprising authorized customers of said plurality of customers that have access to a service function of said plurality of service functions and a total capacity of storage area needed by said authorized customers when using said service function; and code for a license checking routine for receiving a customer request for said service function from said service provider system, and determining if said customer request is within a license limit, said license limit having combinations for said service function of maximum number of users versus maximum total storage capacity allowed for said maximum number of users.

Examples of advantages of some of the embodiments, include: from the viewpoint of users, the access charging method is proper for each user, since the price for accessing each service function of the storage system 124 is in effect paid to the vender by the user via the SSP. From the viewpoint of the SSP, the vender charges the provider for the license for each service function set appropriately to the number of users. Therefore, the charge is decided according to the profit obtained from accessing of the service function, thereby the SSP's business is stabilized. And from the viewpoint of venders, where each storage system provides service functions according to the desired access capacity of users and charges the total number of accesses to the service functions, the accessing of each storage system 124 from users is increased with the expansion of the SSP's business scale, thus increasing the vender's profit.

Although the above functionality has generally been described in terms of specific hardware and software, it would be recognized that the invention has a much broader range of applicability. For example, the software functionality can be further combined or even separated. Similarly, the hardware functionality can be further combined, or even separated. The software functionality can be implemented in terms of hardware or a combination of hardware and software. Similarly, the hardware functionality can be implemented in software or a combination of hardware and software. Any number of different combinations can occur depending upon the application.

Many modifications and variations of the present invention are possible in light of the above teachings. Therefore, it is to be understood that within the scope of the appended claims, the invention may be practiced otherwise than as specifically described.

What is claimed is:

1. A method for providing a plurality of service functions to a plurality of users by a storage system, comprising:
receiving a request by a user of said plurality of users for performance of a service function of said plurality of service functions;
checking if said service function is allowed by said storage system according to a usage constraint, said usage constraint comprising a storage area needed by said service function; and
when said service function is allowed, performing said service function by said storage system.

2. The method of claim 1 wherein said usage constraint further comprises a user number limitation for said service function.

3. The method of claim 1 wherein said receiving said request by said user is via a server provider system (SPS).

4. The method of claim 1 wherein said usage constraint comprises all other storage areas needed by all current user of said service function on said storage system.

5. The method of claim 4 wherein said usage constraint is an accumulation of storage areas of users of said service function.

6. The method of claim 1 wherein all of said plurality of service functions are turned on in said storage system.

7. A method for providing a service function to a user by a storage system, comprising:
receiving a request by a user for performance of a service function;
checking if said service function is allowed by said storage system according to a usage constraint, said usage constraint comprising a storage area needed by said service function; and
when said service function is allowed, performing said service function by said storage system.

8. The method of claim 7 wherein said usage constraint further comprises a user number limitation for said service function.

9. A service provider system for providing a plurality of service functions to a plurality of users, comprising:
a storage system comprising said plurality of service functions, wherein a service function of said plurality of service functions has a predetermined limit on a number of said plurality of users that have access to said service function; and
a service provider server for providing said plurality of users with said plurality of service functions of said storage system.

10. The service provider system of claim 9 further comprising, a second storage system comprising said plurality of service functions, wherein all service functions of said plurality of service functions have been activated for use.

11. The service provider system of claim 9 wherein said storage system further comprises a user access information table for managing data of users of said plurality of users having access to said storage system.

12. The service provider system of claim 9 wherein said service provider system further comprises a data management table including information for identifying a user of said plurality of users, information on said service function, and information for managing data on the user.

13. The service provider system of claim 9 wherein storage system further comprises a user access information table comprising information for identifying a user of said plurality of users and a service function bit map for determining activated service functions of said plurality of service functions for said user.

14. The service provider system of claim 13 wherein said user access information table further comprises an area capacity for each activated service function.

15. A storage system for providing a plurality of service functions to a plurality of users via a service provider system, comprising:
a user access information data structure indicating for a service function of said plurality of service functions selected users of said plurality of users that have access to said service function;
a controller for checking said user access information data structure, when receiving a request from said service provider system for access by a user of said plurality of users to said service function; and
a storage unit having a storage area for use by said service function, when said controller indicates said user has access to said service.

16. The storage system of claim 15 wherein said user access information data structure further comprises a cumulative storage area value for some users of said plurality of users having access to said service function.

17. The storage system of claim 16 wherein said controller checks for user access permission to said service function based on a result dependant upon a number of said some users having access and said cumulative storage area value for said some users.

18. The storage system of claim 15 wherein said result is dependant upon a position with respect to a curve of cumulative storage capacity versus number of users, said curve representing a license from a vender to said service provider.

19. The storage system of claim 15 wherein said user access information data structure is a table.

20. A method for providing a plurality of service functions on a plurality of storage systems to a plurality of users via a service provider system, said method comprising:
said service provider system receiving a request for performance of a service function of said plurality of service functions from a user of said plurality of users;
determining a selected storage system of said plurality of storage systems based on said user and said service function;
calculating a storage area needed by said service function; and
when said storage area added to a total storage area currently required by other users of said service function on said selected storage system does not exceed a predetermined total capacity for said service function on said selected storage system, using said storage area to perform said service function.

21. A method of payment, using a computer, for services from a service provider system to a storage system, wherein said service provider system provides a plurality of service functions of said storage system to a plurality of users, said method comprising:
for a service function of said plurality of service functions, determining a set of limitations based on a total number of users of said service function and a total capacity of storage areas used by said total number of users;
setting a price for each limitation in said set; and
paying a given price for a selected limitation of said set, such that an actual number of users of said service function on said storage system and an actual total capacity of storage area used by said actual number of users does not exceed said selected limitation.

22. The method of payment of claim 21 wherein said storage system checks that said actual number of users and said actual total capacity of storage areas used by said actual number of users does not exceed said limitation.

23. A licensing system of a storage system for monitoring a service provider system having a plurality of customers using a plurality of service functions, comprising:
said plurality of service functions stored on said storage system;
a access table comprising authorized customers of said plurality of customers that have access to a service function of said plurality of service functions and a total capacity of storage area needed by said authorized customers when using said service function; and
a license checking routine for receiving a customer request for said service function from said service provider system, and determining if said customer request is within a license limit, said license limit having a plurality of combinations for said service function dependent on a number of users versus total storage capacity allowed for said number of users.

24. The licensing system of claim 23 further comprising, rejecting said customer request if said customer request is outside said license limit.

25. The licensing system of claim 23 wherein said plurality of combinations of said license limit are grouped into a plurality of sets, each set having an associated licensing fee.

26. A method for registering a new service function specified by a user to a service provider system, said service provider system coupled to a storage system having a controller provided with a plurality of service functions and enabled to control accesses to the plurality of service functions, the method comprising:
enabling the new service function specified by the user in an access information table connected to the controller;
calculating a total area, including a area used by the new service function; and
when the total area does not exceed a predetermined value, registering the new service function in the data management table for the user.

27. A computer program product stored on a computer readable medium for providing a plurality of service functions to a plurality of users by a storage system, said computer program product comprising:
code for receiving a request by a user of said plurality of users for performance of a service function of said plurality of service functions;
code for checking if said service function is allowed by said storage system according to a usage constraint, said usage constraint comprising a storage area needed by said service function; and
code for when said service function is allowed, performing said service function by said storage system.

28. A computer program product stored on a computer readable medium for licensing a service provider system, having a plurality of customers using a plurality of service functions, by a storage system, said computer program product comprising:
code for said plurality of service functions stored on said storage system;
code for a access table comprising authorized customers of said plurality of customers that have access to a service function of said plurality of service functions and a total capacity of storage area needed by said authorized customers when using said service function; and
code for a license checking routine for receiving a customer request for said service function from said service provider system, and determining if said customer request is within a license limit, said license limit having a plurality of combinations for said service function dependent on a number of users versus total storage capacity allowed for said number of users.
